(19) United States
(12) Patent Application Publication
(10) Pub. No.: US 2005/0144617 A1
(43) Pub. Date: Jun. 30, 2005

(54) Automatic configuration of reinstall information

(75) Inventors: Thomas E. Chefalas, Somers, NY (US); Steven J. Mastrianni, Unionville, CT (US)

Correspondence Address: Eric W. Petraske, 68 Old Hawleyville Road, Bethel, CT, 06801, US

(73) Assignee: INTERNATIONAL BUSINESS MACHINES CORPORATION, Armonk, NY (US)

(21) Appl. No.: 10/729,468

(22) Filed: Dec. 6, 2003

(51) Int. Cl. G06F 9/445

(52) U.S. Cl. 717/174

(57) ABSTRACT

A computer system having a backup function keeps only one copy of the operating system and application images on the server, and reconfigures them automatically upon reinstallation. The installation of the system is recorded, along with user settings, and a script file built that is used for input to the recovery or new system creation process.

### TECHNICAL FIELD

The field of the invention is that of computer systems, in particular systems that have provision for recovery of damaged files.

### BACKGROUND OF THE INVENTION

In modern computer systems, a number of user desktop systems are connected to a network that includes at least one server that performs various functions such as electronic mail, distributing updates, etc.

When a user system crashes and the hard disk contents are lost, the system needs to be reinstalled. In an environment where many different configurations and types of systems are installed, this usually requires a specific operating system and application image to be placed on a server for reinstallation if necessary. This creates the need for huge amounts of storage to hold these large images. It would be advantageous to require employ a storage method that requires significantly less disk space.

When a user system crashes and the hard disk contents are lost, the operating system and data needs to be reinstalled on that particular computer.

In an environment where many different configurations and types of systems are installed, this usually requires a specific operating system and application image to be placed on a server for reinstallation if necessary. This creates the need for huge amounts of storage to hold these large images.

Some systems require each user to conform to a standard image, but that prevents the user from using appropriate software.

It would be advantageous to not store the specific images for each configuration, but to store instead a reduced volume of data that could reproduce the individual user's (non-standard) configuration.

### SUMMARY OF THE INVENTION

The present invention relates to a method and apparatus for the automatic reinstallation of the configuration of a workstation in a multi-user computer system.

A feature of the invention is the storage of a small file of parameters specifying what software is to be installed on a user's computer system.

Another feature of the invention is a monitor program that monitors the installation process on a user's system and records the choices made by the user.

### BRIEF DESCRIPTION OF THE DRAWINGS

FIG. 1 illustrates a block diagram of the present invention.

FIG. 2 illustrates a block diagram of an alternative version of the present invention.

### DETAILED DESCRIPTION

The problems described above of requiring massive mounts of storage to provide adequate backup capability for individual users in a multi-user system would be improved if the system did not store the specific images for each configuration, but did store instead a procedure or script that would install the specific configuration from a single instance of the system.

This would result in a considerable saving in which the server did not have to store N copies of the kernel of an operating system, but instead stored a single copy and, for each user, a much smaller file listing the modules that are and are not included in the particular configuration and various parameters required to specify the modules. For convenience in the claims, the term “backup non-specific copies” will be used to indicate the reference copy of the operating system or application program. The term “non-specific” indicates that parameters chosen by a particular user are not included in that copy—e.g. they have the factory defaults.

In operation, each user would have an associated specification, which may be a simple list of the final configuration or preferably a procedure or script that would be executed to install the specific configuration from a single instance of the system. This approach would require significantly less disk space.

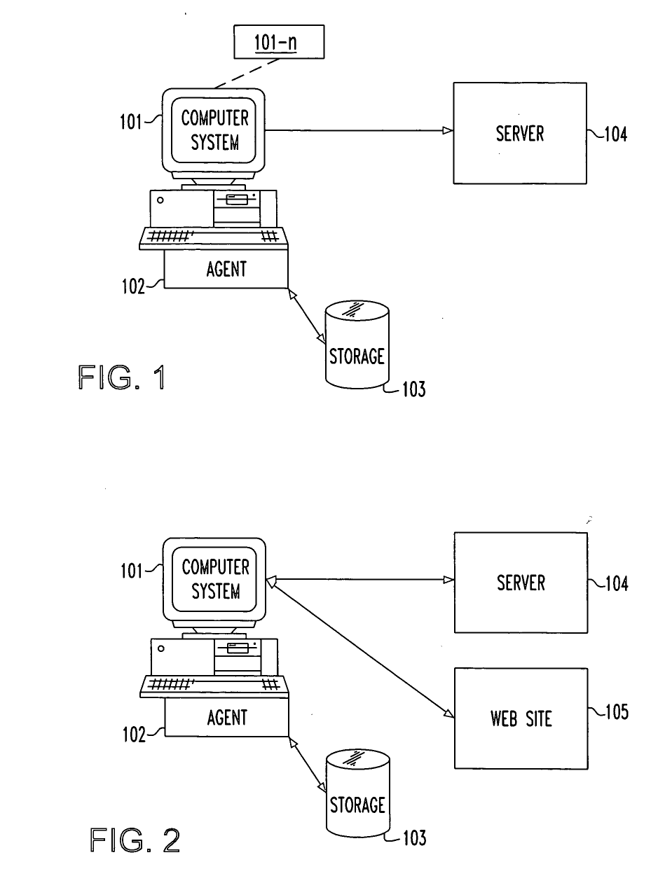

Referring to FIG. 1, there is shown a block diagram of a system according to the invention, comprising server 104 connected to user system 101. Other user systems are indicated schematically by box 101-n. In this example, agent 102 of the present invention monitors the initial installation of the operating system on user system 101 and builds a response file consisting of the inputs provided during the initial operating system installation. This response file is saved to storage 103 or server 104.

For example, the vendor's configuration program may ask: “Do you want in install module X?” The monitor program would record the answer and store it. The list of standard modules in that particular version of the operating system would already have been stored.

The agent also monitors the installation of all applications, noting the file names, where they are placed, and inputs and responses to installation questions, saving this information to storage 103 or server 104.

In one implementation of the present invention, the administrator or installation technician installs the agent on computer system 101 and then installs the operating system. During installation, the settings used for the installation are recorded to the hard disk 103 for later processing. Subsequent installations of applications on the computer system 101 are also recorded, along with their settings.

This incremental recording is then merged with the previous recording and combined into a backup script that is used to install the system on a new computer or one that has had the hard disk drive replaced. This script is then saved to a persistent storage device such as a hard disk, floppy disk, CD, or any other type of persistent storage 103 or server 104.

For example, the vendor of the operating system software typically supplies an installation program that presents the user with a series of choices:—accept the default installation or perform a custom installation. The software agent would record the choices made by the user—e.g. 1) accept the standard installation; 2) accept the standard installation, except substitute a different browser; 3) accept the standard installation, except substitute a different suite of productivity programs, etc.

Once the choices have been recorded, the agent could, at the appropriate time, simply wait for the vendor's installation program to make the requests and play back the user's recorded responses or it could summarize the responses and actively direct the server to install the desired programs without going through the time required to wait for the vendor's installation program to make a request and then reply to it.

Although the recording process above is very convenient, there are other ways of collecting the information to be stored. For example, the user could be required to specify at some convenient time the desired configuration, which the local computer support group will later install. That specification data could also be used as the basis of the storage file; i.e. if and when a backup is needed, the support group would access the storage file and go through the same process to re-install the desired configuration.

In another implementation, suitable for use on existing systems, the present invention takes a snapshot of the current system environment on the computer system 101 and, based on the configuration, builds a response file to be used to reinstall the system fresh and saves the response file to storage 103 or server 104.

This implementation has a further option to upgrade any installed applications, device drivers, or system components to their latest version.

This implementation aids in migration as it allows the user's current configuration to be upgraded and migrated at the same time. The information regarding the installed programs is then used to migrate the data associated with the migrated applications.

This step may require that the data files be converted or upgraded to be used with the newer versions of the installed applications. If conversion or upgrades to the data are required, that operation can be performed at the same time that the applications are migrated.

The scripts are saved as described above, and additionally, the user's data and configuration files are then copied to storage 103 or server 104.

FIG. 2 shows an alternative embodiment of the invention. Once the user information is collected and saved, this information can be used to migrate the current computer system 101 to a new computer system. The agent of the present invention 102 is installed on the new or repaired computer system 101′. The agent then queries storage 103 or server 104 for the installation script. The agent 102 then processes the script to rebuild the computer system 101.

The agent 102 queries the storage 103 or server 104 for the software to install, including operating system, device drivers, and applications. Depending on whether or not the user indicated (or the relevant information system organization requires) that the newest version of certain programs should be installed, the operating system and application images may be loaded from storage 103, server 104, or from an internal or external web site 105.

Alternatively, management of the information technology function in the organization could set parameters on the user's discretion—e.g. some non-supported programs, whether operating systems or applications, will not be upgraded even if the user has requested an upgrade.

The use of the present invention does not require that the local support group will grant a blank check to the users. A user who insists on using an obsolete program or a highly specialized program that is not supported by the support group may or may not be covered by a process according to the invention. For example, the support group could arrange with the users that files in a specified directory(ies) will be backed up and restored in the event of a disk crash, regardless of whether the files are data or non-supported programs. Alternatively, the support group could have an approved list of supported programs that will be backed up, with backup for non-supported programs being left to the user. Other alternatives between the two foregoing ones may be arranged.

Once the operating system and applications have been installed, the agent 102 then queries storage 103 or server 104 for the user's data and loads it into the local hard disk.

In the example shown, the agent program 102 is shown as being resident on the user's computer system, but it could also be located elsewhere, such as on the server. Similarly, the stored backup copies of operating systems and application programs could be on the server, on a separate computer that is not ordinarily connected to the system, on a tape drive, etc.

The local support group will make a decision as to how many operating systems and application programs they will support. More than one operating system (e.g. Windows and Linux) and more than one version of an application program, (e.g. Lotus and Microsoft word processors) might be supported. For convenience in the claims, the stored programs will be referred to as a set of programs, meaning one or more members of the set.

While the invention has been described in terms of a single preferred embodiment, those skilled in the art will recognize that the invention can be practiced in various versions within the spirit and scope of the following claims.

1. A computer system comprising a server and at least one user computer having a user configuration of a user operating system and at least one application program, further comprising:
software means for storing the parameters of said user configuration;
a set of backup non-specific copies, stored in a portion of said system other than said user computer, of a set of operating systems, including said user operating system, and a set of application programs, including said at least one application program; and
software means for restoring said user configuration by copying selected items from said set of backup copies to said user computer in accordance with the parameters of said user configuration.

2. A system according to claim 1, in which said software means monitors user choices during an installation process installing said user configuration.

3. A system according to claim 1, in which said software means records user choices during a parameter specifying process before the installation of said user configuration.

4. A system according to claim 1, in which said software means examines the parameters of an existing user configuration.

5. A system according to claim 2, in which said software means further comprises means for recording incremental changes to said user configuration.

6. A system according to claim 3, in which said software means further comprises means for recording modifications to said user configuration.

7. A system according to claim 4, in which said software means further comprises means for re-examining the parameters of said existing user configuration and recording modifications thereto.

8. A computer system comprising a server and at least one user computer having a user configuration of a user operating system and at least one application program, further comprising:
software means for storing the parameters of said user configuration;
means for accessing a set of backup non-specific copies, stored outside said system, of a set of operating systems, including said user operating system, and a set of application programs, including said at least one application program; and
software means for restoring said user configuration by copying selected items from said set of backup copies to said user computer in accordance with the parameters of said user configuration.

9. A system according to claim 8, in which said software means monitors user choices during an installation process installing said user configuration.

10. A system according to claim 8, in which said software means records user choices during a parameter specifying process before the installation of said user configuration.

11. A system according to claim 8, in which said software means examines the parameters of an existing user configuration.

12. A system according to claim 9, in which said software means further comprises means for recording incremental changes to said user configuration.

13. A system according to claim 10, in which said software means further comprises means for recording modifications to said user configuration.

14. A system according to claim 11, in which said software means further comprises means for re-examining the parameters of said existing user configuration and recording modifications thereto.

15. An article of manufacture in computer readable form comprising means for performing a method for operating a computer system comprising a server and at least one user computer having a user configuration of a user operating system and at least one application program, said method comprising the steps of:
storing the parameters of said user configuration;
storing a set of backup non-specific copies, stored in a portion of said system other than said user computer, of a set of operating systems, including said user operating system, and a set of application programs, including said at least one application program; and
restoring said user configuration by copying selected items from said set of backup copies to said user computer in accordance with the parameters of said user configuration.

16. An article of manufacture according to claim 15, further comprising a step of monitoring user choices during an installation process installing said user configuration.

17. An article of manufacture according to claim 15, further comprising a step of recording user choices during a parameter specifying process before the installation of said user configuration.

18. An article of manufacture according to claim 15, further comprising a step of examining the parameters of an existing user configuration.

19. An article of manufacture according to claim 16, further comprising a step of recording incremental changes to said user configuration.

20. An article of manufacture according to claim 17, further comprising a step of recording modifications to said user configuration.

21. An article of manufacture according to claim 18, further comprising a step of re-examining the parameters of said existing user configuration and recording modifications thereto.
